(19) United States
(12) Patent Application Publication
(10) Pub. No.: US 2010/0153477 A1
(43) Pub. Date: Jun. 17, 2010

(54) METHOD OF CALCULATING TRANSPORT BLOCK SIZES IN COMMUNICATION SYSTEM

(76) Inventor: Yu Tang Chou, Yun Lin County (TW)

Correspondence Address: Muncy, Geissler, Olds & Lowe, PLLC, 4000 Legato Road, Suite 310, FAIRFAX, VA, 22033, US

(21) Appl. No.: 12/635,462

(22) Filed: Dec. 10, 2009

(30) Foreign Application Priority Data
Dec. 11, 2008 (TW) 097148142

(51) Int. Cl. G06F 7/552; G06F 5/01; G06F 17/16

(52) U.S. Cl. 708/209; 708/606; 708/517; 708/607

(57) ABSTRACT

A method of calculating a transport block size in an HSPA receiver of a communication system is provided. After decomposing an exponential function P^{k} into a plurality of constant vectors, the invention needs only little memory space and executes few continued multiplication operations to obtain a correct transport block size, thereby increasing efficiency and reducing calculation complexity.

This application claims the benefit of the filing date of Taiwan Application Ser. No. 097148142, filed on Dec. 11, 2008, the content of which is incorporated herein by reference.

### BACKGROUND OF THE INVENTION

1. Field of the Invention

The invention relates to high-speed packet access (HSPA) technique, and more particularly, to a method of calculating transport block sizes for HSPA receivers.

2. Description of the Related Art

In a HSPA receiver, it is necessary to obtain a transport block size by calculating a complicated mathematical equation (1): L(k)=└Lₘᵢₙ×P^{k}┘×δ, prior to decoding data. However, different communication systems define different values of parameters P, Lₘᵢₙ, δ and k. For example, P=2085/2048, Lₘᵢₙ=296, δ=1 and k=40˜254 comply with the 3GPP FDD specifications with high speed download packet access (HSDPA) platform. In the process of calculating equation (1), calculating the exponential function P^{k} is the most complicated part. Hereinafter, three conventional methods of calculating the exponential function P^{k} will be described briefly.

The first is the exhausted multiplication method. The key problem of calculating equation (1) in digital signal processor (DSP) is how to deal with the calculation of P^{k}. P is a real-number constant but not an integer, and this method simply performs repeated multiplication of P with k times when k is an integer. The most advantage of this method is simple and straight-forward. That is, performing repeated multiplication of P k times will arrive at a solution. In contrast, its disadvantage is a high volume of multiplication. Generally, each DSP has one to two embedded multipliers. When k is very large, e.g., 250, a DSP needs to perform iterative operations, and thus requires long latency.

The second is the log-domain method. The calculation of exponential function P^{k} is converted to the log domain, i.e., Pk=e^{(k*In(P))}. Here, e^{(k*ln(P))} can be expressed as a notation e^{(I+F)}, where I denotes the integral part and F denotes the fractional part. Calculating e^{I} is to perform repeated multiplication of e with I times while the method of calculating e^{F} is disclosed in the U.S. Pat. No. 4,979,139 and the algorithm proposed by Israel Koren (“Computer Arithmetic Algorithms,” Natick, Mass.: A. K. Peters, c2002, ISBN 1-56881-160-8) as shown in FIG. 1. Referring to FIG. 1, m_{F} denotes the total number of bits to express F. Step S106 performs pseudo division while steps S110, S112, S114 and S116 perform pseudo multiplication. The advantage of the log-domain method is that few multiplication operations are required and it needs only adders, substractors and logic operation units instead of multipliers to calculate e^{F}. Its disadvantages are as follows. (1) When k is an integer, the converted e^{(k*ln(P))} still needs to perform repeated multiplication of e with (I+2) times (including k×ln(P) and e^{I}×e^{F}), where I is related to ln(P). If ln(P)>1, their related operations are more complicated than the exhausted multiplication method. (2) Calculating e^{F} needs to repeat the iterative operations with m_{F} times. Therefore, its latency will become longer as m_{F} is getting larger. (3) Calculating e^{(k*ln(P))} needs to consult a look-up table, thus requiring a additional memory space of (mₑ+m_{lnP)}+m_{F}×m_{F}) bits, where mₑ denotes the number of bits to express e and m_{ln(P)} denotes the number of bits to express ln(P). Accordingly, the corresponding memory space for operations will become larger as m_{F} is getting larger.

The third is the look-up table method. A huge memory space is needed to store a very large table.

### SUMMARY OF THE INVENTION

In view of the above-mentioned problems, an object of the invention is to provide a method of calculating a transport block size in an HSPA receiver of a communication system, which needs only little memory space and executes few continued multiplication operations to obtain a correct transport block size by means of decomposing an exponential function P^{k} into a plurality of constant vectors, thereby increasing efficiency and reducing calculation complexity.

To achieve the above-mentioned object, the method of calculating a transport block size is applied in a high-speed packet access (HSPA) receiver of a communication system and the communication system receives a parameter k. The method comprises: sequentially comparing each bit of k in binary with a predetermined value and selecting one from n preset constant vectors by the HSPA receiver, when a corresponding bit of k in binary equals the predetermined value; performing continued multiplication operations of all selected preset constant vectors to obtain a value of an exponential function P^{k}; and, calculating the transport block size according to parameters Lₘᵢₙ and δ and the value of the exponential function P^{k} using a following equation: L(k)=└Lₘᵢₙ×P^{k}┘×δ, wherein L(k) denotes the transport block size, P, Lₘᵢₙ and δ are constants and k is an integer.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart showing a method of calculating e^{F} according to prior art.

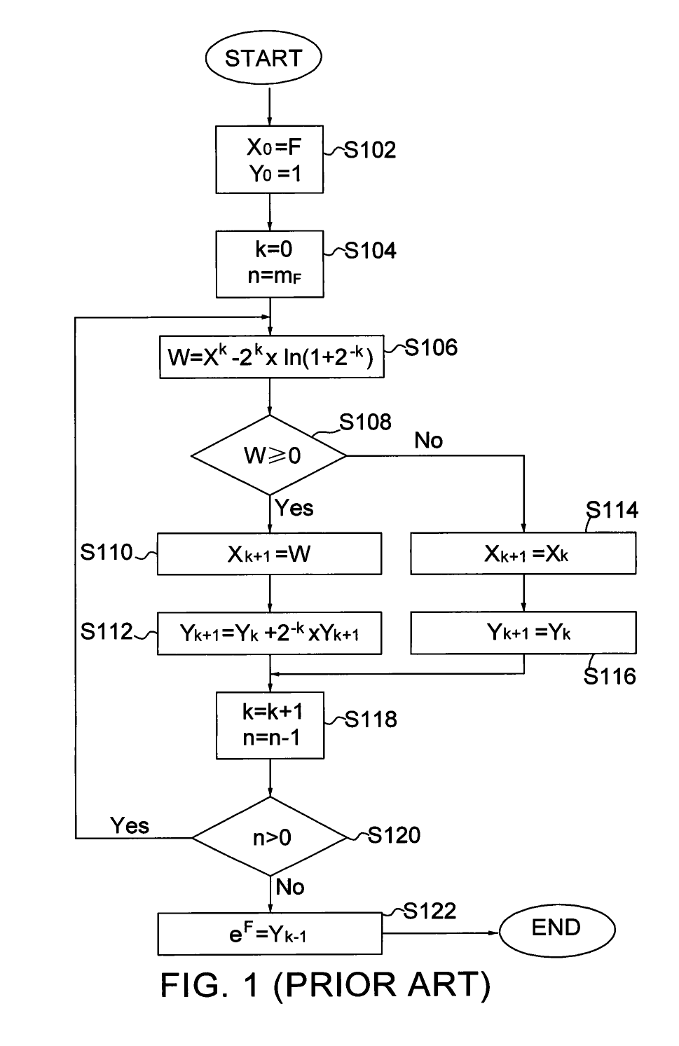

FIG. 2 is a flow chart showing a method of calculating the exponential function P^{k} according to the invention.

FIG. 3 is a flow chart showing a method of determining the preset constant vectors ρᵢ according to the invention.

FIG. 4 shows an experimental result comparing the prior arts and the method of calculating the exponential function of the invention.

### DETAILED DESCRIPTION OF THE INVENTION

In the present disclosure, numerous specific details are provided, such as examples of electrical circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

With respect to equation (1): L(k)=└Lₘᵢₙ×P^{k}┘×δ, where P is a constant fraction whose numerator is not divisible by its denominator. Therefore, the most complicated calculation is to deal with the exponential function P^{k}. The concept of linear algebra is provided to decompose the exponential function P^{k} into n constant vectors, where k is a variable integer in the range of kr and n denotes the number of the constant vectors in the range of kr after the exponential function P^{k} is decomposed, i.e. n=┌log₂(max(kr))┐. Thereby, the exponential function P^{k} can be expressed as the following equation:

$$\begin{matrix}{P}^{k} \approx {ρ}^{( {k}_{n - 1} \times {2}^{n - 1} + … + {k}_{2} \times {2}^{2} + {k}_{1} \times {2}^{1} + {k}_{0} \times {2}^{0} )} \\ = {ρ}^{{k}_{n - 1} \times {2}^{n - 1}} \times … \times {ρ}^{{k}_{2} \times {2}^{2}} \times {ρ}^{{k}_{1} \times {2}^{1}} \times {ρ}^{{k}_{0} \times {2}^{0}} , {k}_{i} ∈ \{ 0 , 1 \} \\ = {ρ}_{n - 1}^{{k}_{n - 1}} \times … \times {ρ}_{2}^{{k}_{2}} \times {ρ}_{1}^{{k}_{1}} \times {ρ}_{0}^{{k}_{0}}\end{matrix} \qquad ( 2 )$$

where ρᵢ=ρ²^{ⁱ}, ρ²^{ⁱ}≈(P²^{ⁱ}+σ) and i=0 to (n−1).

Because there is no real number as an infinite decimal in practical systems, a nearby finite decimal with limited bits is usually used to approximate to the infinite decimal, and the bit width of the finite decimal depends on the system precision. In equation (2), ρ²^{ⁱ} denotes an approximate value of P²^{ⁱ}, and σ denotes a correction parameter indicative of the reduced number of bits after ρ²^{ⁱ} provided to approximate to P²^{ⁱ}. In general, the bit width (i.e. precision) of each constant vector ρ²^{ⁱ} is related to both Lₘᵢₙ and the maximum value in the range of kr with respect to equation (1). According to the invention, by using equation (2), the complicated exponential function calculation is simplified to performing continued multiplication of n constant vectors ρᵢ. Compared with k, n is a relatively small value, and thus the calculation complexity is greatly reduced.

As mentioned above, different systems define different values of P, Lₘᵢₙ, δ and kr, so the corresponding values of constant vectors ρᵢ for each system will be different. With regard to a specific system (e.g., system A) supported by a HSPA receiver, a corresponding set of constant vectors ρᵢ has to be calculated in advance and stored in nonvolatile memory before the HSPA receiver comes into the market. When the HSPA receiver operates under system A and receives P, Lₘᵢₙ, δ and k, the value of the exponential function P^{k} is obtained by performing continued multiplication of constant vectors ρᵢ at most ┌log₂(k)┐ times. Thereafter, the transport block size L(k) is obtained by taking the integer part of the product of Lₘᵢₙ, δ and the value of the exponential function P^{k}. Alternatively, if the HSPA receiver is able to support multiple systems, multiple sets of constant vectors ρᵢ have to be calculated and stored in advance. Afterwards, according to one of the systems accessed, a corresponding set of constant vectors ρᵢ will be fetched and provided to perform continued multiplication operations.

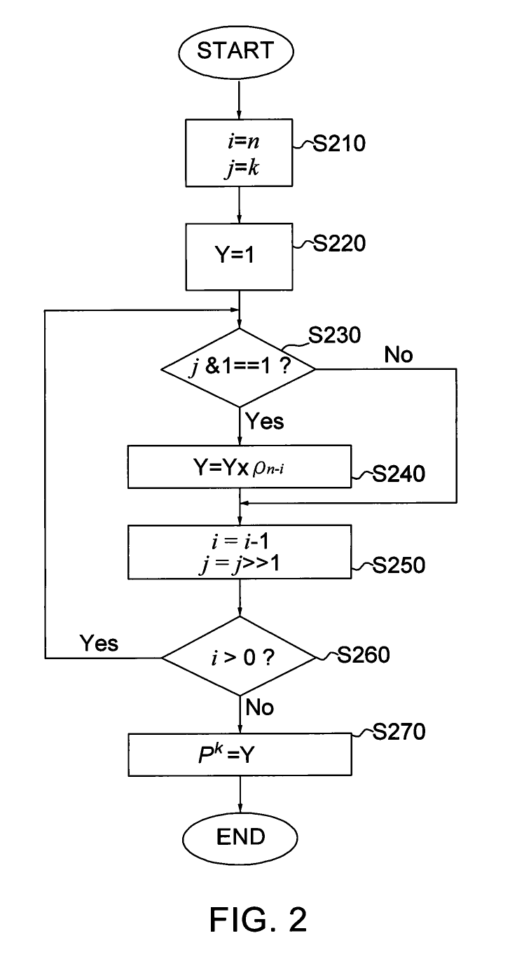

FIG. 2 is a flow chart showing a method of calculating the exponential function P^{k} according to the invention. Given that Lₘᵢₙ=100, δ=1, kr=1 to 7 and P=2085/2048. Thus, n=┌log₂(max(7))┐)=3. According to the invention, three preset constant vectors ρᵢ(ρᵢ=ρ²^{ⁱ}, i=0 to (n−1)) within the range of kr are obtained in advance as follows: ρ₀=(1.000001001)₂, ρ₁=(1.000010010)₂, ρ₂=(1.000100110)₂. According to equation (2), the value of the exponential function P^{k} approximates to the product of the corresponding preset constant vectors)ρᵢ.

Step S210: Set a variable j equal to k and a variable i equal to n (i=n=┌log₂(max(5))┐)=3) according to a value of k (assuming k=5) received by the HSPA receiver.

Step S220: Set a variable Y equal to 1 (Y=1). The variable Y is set to an initial value in this step.

Step S230: Check if (j&1==1), where “&” denotes a bitwise AND operator and “==” denotes an equality operator. This step is used to check if a least significant bit (LSB) of j is equal to 1. If it is true, the flow goes to the step S240; otherwise, the flow goes to the step S250.

Step S240: Y=Y×ρₙ₋ᵢ. This step is used to multiply the current value of Y by ρₙ₋ᵢ.

Step S250: i=i−1, j=j>>1, where “>>” denotes a right shift operator. In other words, the value of i is decreased by one and j is shifted one place to the right.

Step S260: Check if i is greater than zero. If it is true, the flow returns to the step S230; otherwise, the flow goes to the step S270.

Step S270: P^{k}=Y. In this embodiment, k=(5)₁₀=(101)₂. Since only bit 0 and bit 2 of k in binary are equal to 1, the exponential function P^{k}=Y=ρ₀×ρ₂.

After obtaining the value of exponential function P^{k}, it is easy to compute the transport block size L(5)=105 by multiplying the value of exponential function P^{k} by Lₘᵢₙ and δ according to equation (1). In the above-mentioned embodiment, j is shifted one place to the right sequentially, and then, the value of the LSB of j determines whether to multiply Y by a corresponding preset constant vector ρᵢ. In another embodiment, j is shifted one place to the left sequentially, and then, the value of the most significant bit (MSB) of j determines whether to multiply Y by a corresponding preset constant vector ρᵢ. In the step S230, it checks if (j&(100)₂) is equal to (100)₂. In the step S240, it calculates Y=Y×ρᵢ₋₁. In the step S250, j is shifted one place to the left (j=j<<1, where “<<” denotes a left shift operator). The operations of the other steps are the same as those described in FIG. 2.

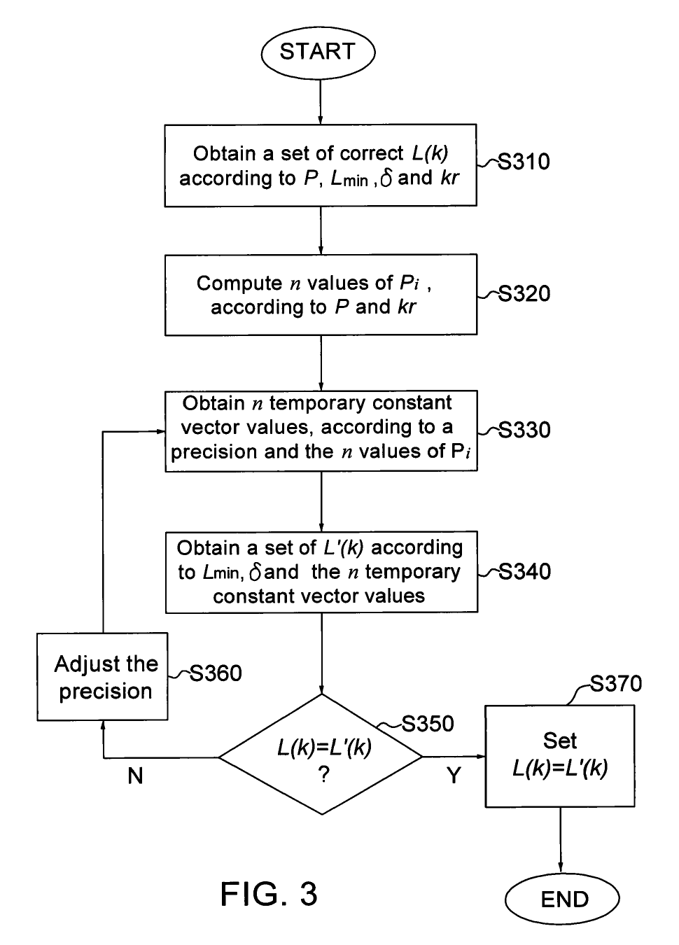

FIG. 3 is a flow chart showing a method of determining the preset constant vectors ρᵢ according to the invention. According to FIG. 3, the method of determining the preset constant vectors ρᵢ is described with reference to FIG. 3.

Step S310: Obtain one set of correct transport block sizes L(k) for each k within the range of kr according to the parameters P, Lₘᵢₙ, δ and kr. According to the values of P, Lₘᵢₙ, δ and kr mentioned in the description of FIG. 2, a set of correct transport block sizes L(k) for each k within the range of kr are shown as follows: L(1)=101, L(2)=103, L(3)=105, L(4)=107, L(5)=109, L(6)=111 and L(7)=113.

Step S320: Calculate n exponential-function representing values using the equation Pᵢ=P²^{ⁱ}, where i=0 to (n−1). As can be known from the description of FIG. 2, since n=3, by plugging the value (=2085/2048) of P into the equation Pᵢ=P²^{ⁱ}, three exponential-function representing values Pᵢ are obtained as follows.

P₀=(1.01806640625 . . . )₁₀=(1.00000100101000000000 . . . )₂

P₁=(1.03645920753 . . . )₁₀=(1.00001001010101010110 . . . )₂

P₂=(1.07424768888 . . . )₁₀=(1.00010011000000011110 . . . )₂

Step S330: Obtain n temporary constant vector values ρᵢ′ (ρᵢ′=ρ²^{ⁱ}, i=0 to (n−1)) according to a precision (in unit of bit) and the n exponential-function representing values Pᵢ. Assuming that each of the n exponential-function representing values Pᵢ is rounded to seven decimal places (precision=8) firstly, three temporary constant vectors ρᵢ′ are obtained as follows: ρ₀′=(1.0000010)₂=(1.0156250)₁₀, ρ₁′=(1.0000100)₂=(1.0312500)₁₀ and ρ₂′=(1.0001001)₂=(1.0703125)₁₀.

Step 340: Given that the precision is equal to 8, obtain a set of temporary transport block sizes L′(k) according to Lₘᵢₙ, δ and the three temporary constant vectors ρᵢ′ when the presion is equal to 8. When the presion is equal to 8, according to the three temporary constant vectors ρᵢ′ and the parameters Lₘᵢₙ and δ, a set of temporary transport block sizes L′(k) are obtained as follows: L′(1)=101, L′(2)=103, L′(3)=104, L′(4)=107, L′(5)=108, L′(6)=110 and L′(7)=112.

Step S350: Check if two sets of the transport block sizes L(k) and L′(k) are equal within the range of kr. When two sets of the transport block sizes L(k) and L′(k) are fully identical, the flow goes to the step S370; otherwise, the flow goes to step S360. Given that the precision is equal to 8, it can be observed from the above-mentioned two sets of the transport block sizes L(k) and L′(k), where L′(3)≠L(3), L′(5)≠L(5), L′(6)≠L(6) and L′(7)≠L(7).

Step S360: Adjust the precision and return to the step S330. In general, the accuracy will increase as the precision is increased; however, the complexity of multiplication operations is grown as well. Thereby, an optimum condition is to make L(k) and L′(k) fully identical with the minimum precision.

Step S370: Set the preset constant vector ρᵢ equal to the temporary constant vector ρᵢ′. In terms of the parameters as mentioned above, the precision has to be increased up to 10 bits (i.e., the value of Pᵢ is rounded to nine decimal places) to make two sets of the transport block sizes L(k) and L′(k) fully identical. At the moment, the three preset constant vectors ρᵢ′ are set to the following three temporary constant vectors ρᵢ′ as follows: ρ₀=ρ₀′=(1.000001001)₂, ρ₁=ρ₁′=(1.000010010)₂ and ρ₂=ρ₂′=(1.000100110)₂.

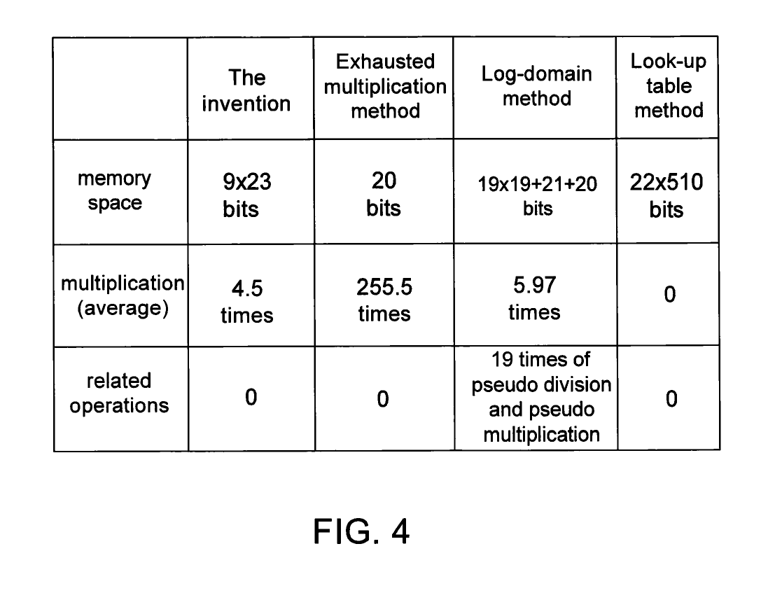

FIG. 4 shows an experimental result comparing the prior arts and the method of calculating the exponential function of the invention.

Given that P=(2085/2048), k=1 to 510 and m_{F}=19, as can be observed from FIG. 4, four different specific forms of complexity are provided to calculate the exponential function P^{k}. The exhausted multiplication method directly performs repeated multiplication of P. Although only a 20-bit memory space is needed to store the value of P, an average of 255.5 times of iterative multiplication has to be performed, making a great complexity of calculation. As for the log-domain method, an average of 5.97 times of multiplication operations and an average of 19 times of pseudo division operations and pseudo multiplication operations have to be performed for operations with an additional (19×19+41)-bit memory space. Besides, its latency is taken longer since the pseudo division and the pseudo multiplication are iterative operations. The look-up table method can directly obtain the results but needs very large memory space (22×510 bits) to store a huge table. By contrast, the invention simply performs an average of 4.5 times of multiplication operations and needs a (9×23)-bit memory space to store 9 preset constant vectors ρᵢ.

As can be observed from FIG. 4, the invention has the following three advantages. (1) Less multiplication operations will be needed in the invention. There are at most n (=┌log₂(max(k))┐) times of multiplication operations needed in the invention. Compared with the prior arts, the invention needs the least times of multiplication operations when k is very large. (2) Less memory space will be needed in the invention. The invention only needs to store n preset constant vectors ρᵢ. For example, if “a” denotes the number of bits or the precision required for storing a preset constant vector, a (n×a)-bit memory space is enough to achieve the best operation efficiency. (3) The invention has higher execution speed and efficiency: compared with the log-domain method, the invention only determines which constant vectors are used to perform continued multiplication operations instead of performing pseudo division operations and pseudo multiplication operations. Therefore, according to the invention, few continued multiplication operations are performed to obtain a correct result with little memory space, thereby obviously increasing efficiency and reducing calculation complexity.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method for calculating a transport block size applied in a high-speed packet access(HSPA) receiver of a communication system, the communication system receiving a parameter k, the method comprising:
sequentially comparing each bit of k in binary with a predetermined value and selecting one from n preset constant vectors by the HSPA receiver, when a corresponding bit of k in binary equals the predetermined value;
performing continued multiplication operations of all selected preset constant vectors to obtain a value of an exponential function P^{k}; and
calculating the transport block size according to parameters Lₘᵢₙ and δ and the value of the exponential function P^{k} using a following equation: L(k)=└Lₘᵢₙ×P^{k}┘×δ,
wherein L(k) denotes the transport block size, P, Lₘᵢₙ and δ are constants and k is an integer.

2. The method according to claim 1, wherein the value of the exponential function P^{k} is given by a following equation:
P^{k}=ρₙ₋₁^{k}^{ₙ₋₁}× . . . ×ρ₂^{k}^{₂}×ρ₁^{k}^{₁}×ρ₀^{k}^{₀}, wherein
ρₙ₋₁ to ρ₀ denote the n preset constant vectors respectively and
kₙ₋₁ to k₀ respectively denote n bits of a binary representation of k.

3. The method according to claim 2, wherein n is the total number of bits required to express k.

4. The method according to claim 3, wherein n is ┌log₂(max(kr))┐.

5. The method according to claim 1, wherein the step of sequentially comparing comprises:
comparing a least significant bit (LSB) of k in binary with the predetermined value;
selecting a corresponding preset constant vector when the LSB of k in binary equals the predetermined value;
shifting k to the right one place; and
repeating the foregoing three steps until all the bits of k in binary have been compared.

6. The method according to claim 1, wherein the step of sequentially comparing comprises:
comparing a most significant bit (MSB) of k in binary with the predetermined value;
selecting a corresponding preset constant vector when the MSB of k in binary equals the predetermined value;
shifting k to the left one place; and
repeating the foregoing three steps until all the bits of k in binary have been compared.

7. The method according to claim 2, further comprising:
obtaining the n preset constant vectors.

8. The method according to claim 7, wherein the step of obtaining the n preset constant vectors comprises:
obtaining a set of first transport block sizes according to P, Lₘᵢₙ, δ and a range parameter kr, wherein k is in the range of kr,
calculating n exponential-function representing values according to P and n;
obtaining n temporary constant vectors according to a precision and the n exponential-function representing values, wherein the precision indicates the bit width of each temporary constant vector;
obtaining a set of second transport block sizes according to the n temporary constant vectors, Lₘᵢₙ and δ;
determining whether the set of the first transport block sizes equal the set of the second transport block sizes according to kr;
setting the n preset constant vectors equal to the n temporary constant vectors when the set of the first transport block sizes equal the set of the second transport block sizes; and
adjusting the precision and returning to the step of obtaining the n temporary constant vectors when the set of the first block sizes are not equal to the set of the second transport block sizes.

9. The method according to claim 8, wherein the n exponential-function representing values are given by a following equation:
Pᵢ=P²^{ⁱ}, wherein i=0 to (n−1).
